(19) United States
(12) Patent Application Publication
(10) Pub. No.: US 2025/0178249 A1
(43) Pub. Date: Jun. 5, 2025

(54) Safety device for Hydraulic Press

(71) Applicant: Changzhou City Chen Xin Environmental Protection Technology Co., Ltd., Changzhou City (CN)

(72) Inventors: Tzung-Shen LAI, Changzhou City (CN); Shih-Ping WEI, Changzhou City (CN)

(21) Appl. No.: 18/525,873

(22) Filed: Dec. 1, 2023

(51) Int. Cl. B29C 43/58; B29C 37/00; B29C 43/32; B29C 43/36

(52) U.S. Cl. CPC B29C 43/58; B29C 37/00; B29C 43/36; B29C 2037/94; B29C 2043/3283

(57) ABSTRACT

A safety device for a hydraulic press contains: a bottom plate. The bottom plate includes a through orifice and a pull stud inserted through the through orifice. The pull stud includes a shank and at least one defining ring, and the bottom plate includes a clamper which has an abutting projection mounted above a top of the bottom plate. The abutting projection has two tilted swing arms rotatably connected on two sides thereof, and two extensions of the two tilted swing arms are located on two sides of the pull stud. A respective one tilted swing arm includes an elongated orifice extending thereon from a central section of the respective one tilted swing arm, and the elongated orifice slidably accommodates a guide rod. The bottom plate further includes a drive device mounted thereon and located behind the abutting projection, and the drive device includes a pushing element.

### TECHNICAL FIELD

The present invention relates to a safety device for a hydraulic press.

### BACKGROUND

When a hydraulic system causes leakage after a mold holder of a conventional hydraulic press moves upward, the mold holder crawls or drops to have an accident. Also, the safety device of the conventional hydraulic press has a poor loading capacity that cannot be applicable for the hydraulic press with a large tonnage. Alternatively, when the hydraulic press has a large loading capacity, but it is complicated and has a high maintenance cost.

The present invention has arisen to mitigate and/or obviate the afore-described disadvantages.

### SUMMARY

The primary aspect of the present invention is to provide a safety device for a hydraulic press which is capable of enhancing using safety.

To obtain above-mentioned aspect, a safety device for a hydraulic press provided by the present invention contains: a bottom plate.

The bottom plate includes a through orifice and a pull stud inserted through the through orifice. The pull stud includes a shank and at least one defining ring, and the bottom plate includes a clamper which has an abutting projection mounted above a top of the bottom plate. The abutting projection has two tilted swing arms rotatably connected on two sides thereof, and two extensions of the two tilted swing arms are located on two sides of the pull stud. A respective one tilted swing arm includes an elongated orifice extending thereon from a central section of the respective one tilted swing arm, and the elongated orifice slidably accommodates a guide rod. The bottom plate further includes a drive device mounted thereon and located behind the abutting projection, and the drive device includes a pushing element.

### BRIEF DESCRIPTION OF THE DRAWINGS

FIG. 1 is a perspective view showing the assembly of a safety device for a hydraulic press according to a preferred embodiment of the present invention.

FIG. 2 is a perspective view showing the exploded components of FIG. 1 according to the preferred embodiment of the present invention.

FIG. 3 is a top plan view of FIG. 1 according to the preferred embodiment of the present invention.

FIG. 4 is a top plan view showing the clamper being in a clamping state according to the preferred embodiment of the present invention.

FIG. 5 is a cross sectional view of FIG. 3 according to the preferred embodiment of the present invention.

FIG. 6 is a cross sectional showing the application of the safety device for the hydraulic press according to the preferred embodiment of the present invention.

### DETAILED DESCRIPTION

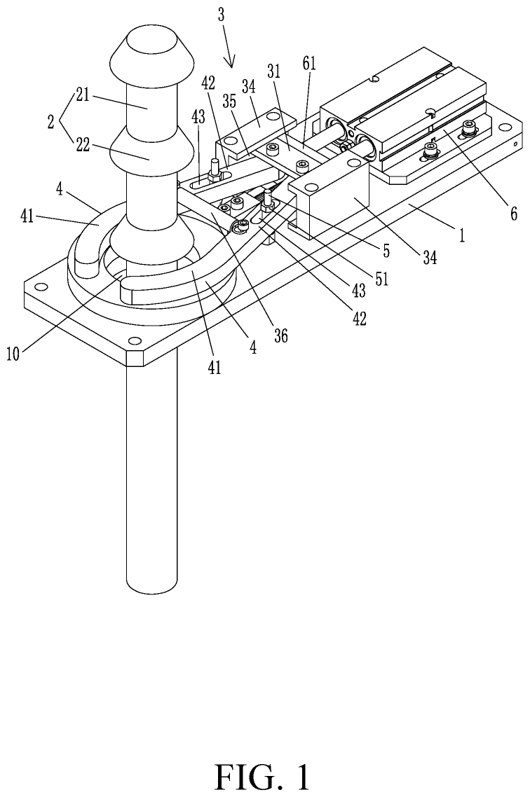

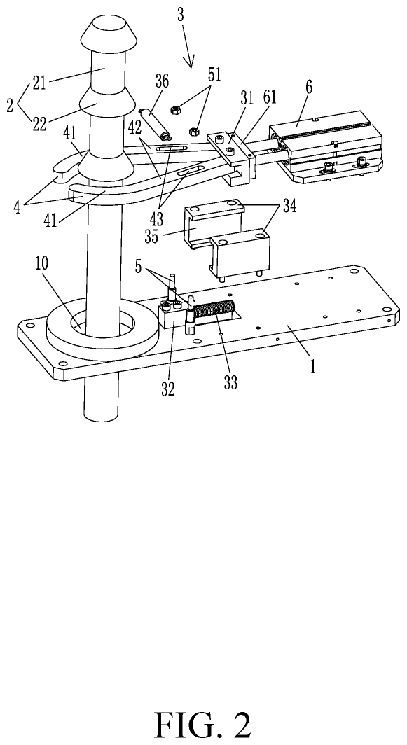

With reference to FIGS. 1-5, a safety device for a hydraulic press according to a preferred embodiment of the present invention comprises: a bottom plate 1, and the bottom plate 1 includes a through orifice 10 defined thereon and a pull stud 2 inserted through the through orifice 10, wherein the pull stud 2 includes a shank 21 and at least one defining ring 22 fitted on the shank 21. The bottom plate 1 further includes a clamper 3, and the clamper 3 has an abutting projection 31 mounted above a top of the bottom plate 1, wherein the abutting projection 31 has two tilted swing arms 4 rotatably connected on two sides thereof, and two extensions 41 of the two tilted swing arms 4 are located on two sides of the pull stud 2, a respective one tilted swing arm 4 includes an elongated orifice 43 extending thereon from a central section 42 of the respective one tilted swing arm 4, and the elongated orifice 43 of the respective one tilted swing arm 4 slidably accommodates a guide rod 5, wherein an end of the guide rod 5 is fixed on the bottom plate 1, and the bottom plate 1 further includes a drive device 6 mounted thereon and located behind the abutting projection 31, wherein the drive device 6 includes a pushing element 61.

In this embodiment, the drive device 5 is a cylinder. In another embodiment, the drive device 5 is a screw-nut mechanism so that a screw rod of the drive device 5 is configured to push the abutting projection 31 to move forward. Also, the drive device 5 is any one of a crank-slider mechanism, a hydraulic cylinder, and a cam mechanism. In this embodiment, the drive device 5 is the cylinder to reduce a cost.

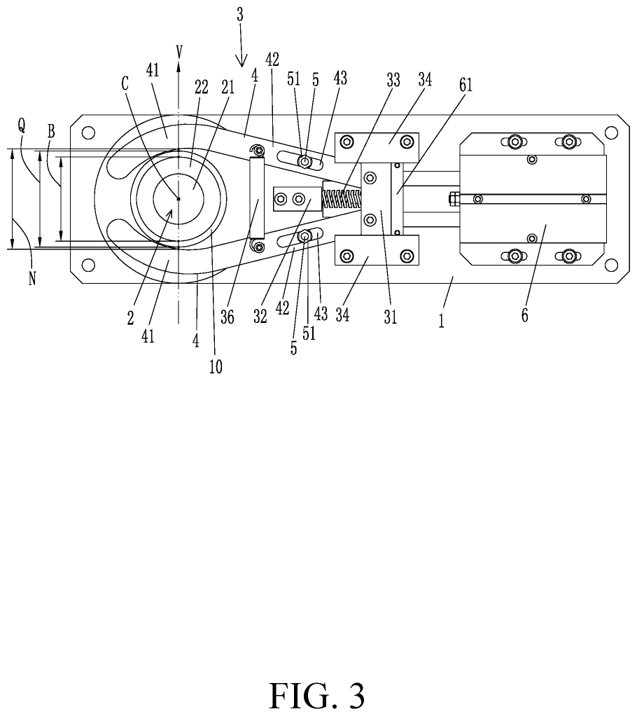

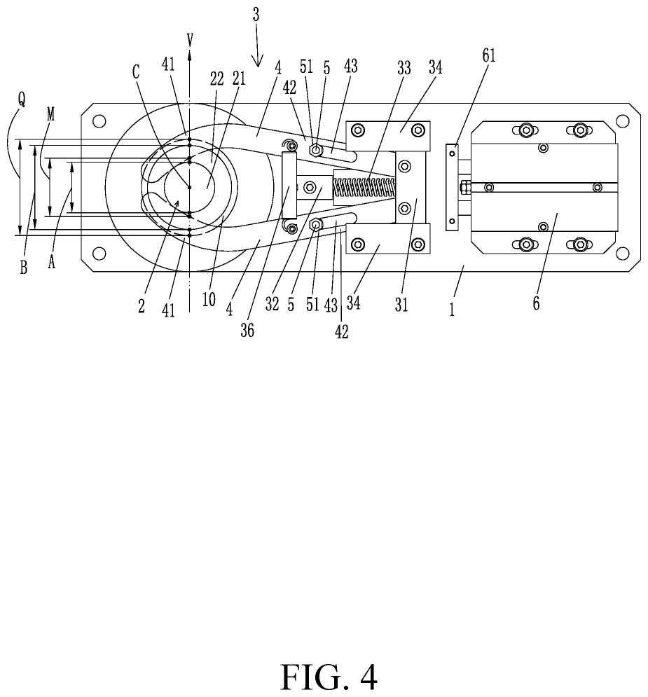

FIGS. 3 and 4 are a top plan view of the mold locking mechanism, wherein the through orifice 10 of the bottom plate 1 is circular, a central point C of the through orifice 10 is a datum point from which a virtual longitudinal axis V extends, a diameter A of the shank 21 of the pull stud 2 and a diameter B of a respective one defining ring 22 are smaller than a diameter of the through orifice 10, i.e., A<Q, B<Q.

The clamper 3 is configured to clamp or unclamp a workpiece (not shown). In an original state, the clamper 3 is in the clamping state, wherein two extensions 41 of the two tilted swing arms 4 move close to each other to produce a gap M, and the gap M of the two extensions 41 on the virtual longitudinal axis V is smaller than a diameter B of the respective one defining ring 22 of the pull stud 2, i.e., M<B, such that the respective one defining ring 22 of the pull stud 2 does not pass across the gap M of the two extensions 41 of the two tilted swing arms 4 in the clamping state. The pushing element 61 of the drive device 6 pushes the abutting projection 31 to move forward, thus switching the clamper 3 to be in an unclamping state. In other words, the two extensions 41 of the two tilted swing arms 4 are spaced from each other so that a gap N of the two extensions 41 of the two tilted swing arms 4 on the virtual longitudinal axis V is larger than a diameter B of the respective one defining ring 22 of the pull stud 2, i.e., N>B. Also, When the two extensions 41 of the two tilted swing arms 4 are spaced from each other, the gap N of the two extensions 41 of the two tilted swing arms 4 on the virtual longitudinal axis V is larger than a diameter Q of the through orifice 10 of the bottom plate 1, i.e., N>Q, such that the respective one defining ring 22 of the pull stud 2 passes across the gap N of the two extensions 41 of the two tilted swing arms 4, when the two extensions 41 of the two tilted swing arms 4 are spaced from each other.

The bottom plate 1 further includes a positioning protrusion 32 connected with the abutting projection 31 and at least one returning spring 33 defined between the positioning protrusion 32 and the abutting projection 31, wherein a first end of the returning spring 33 abuts against the positioning protrusion 32, and the other end of the returning spring 33 contacts with and pushes the abutting projection 31. In other words, the abutting projection 31 is pushed by the returning spring 33 to move rearward so that the clamper 3 is switched to be in the clamping state from the original state.

The abutting projection 31 has two guiding blocks 34 extending from two sides thereof and located on the bottom plate 1, and the two guiding blocks 34 have two slide grooves 35 defined therein, wherein the abutting projection 31 is slidably defined between the two slide grooves 35.

At least one tension spring 36 is defined between the two tilted swing arms 4 and is located ahead of the guide rod 5, wherein the at least one tension spring 36 is configured to switch the clamper 3 to be in the clamping state from the unclamping state, and the clamper 3 is in the clamping state when in the original state.

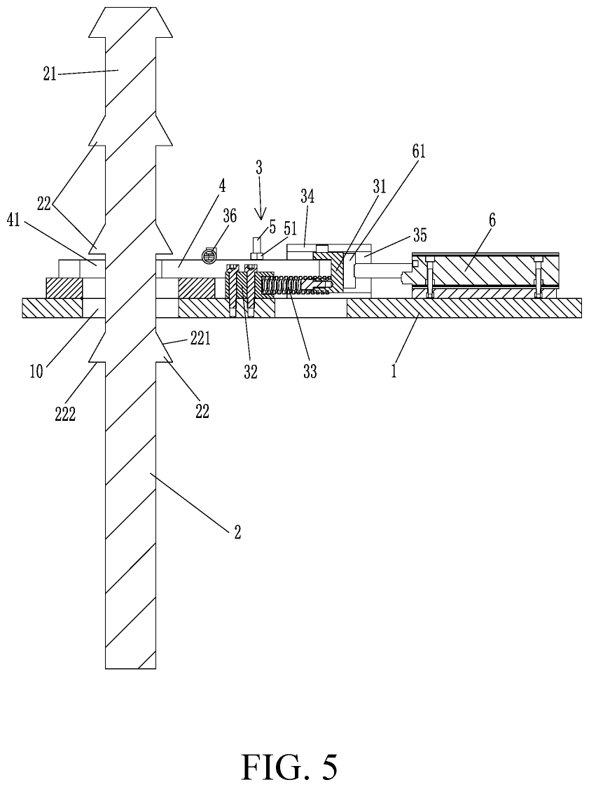

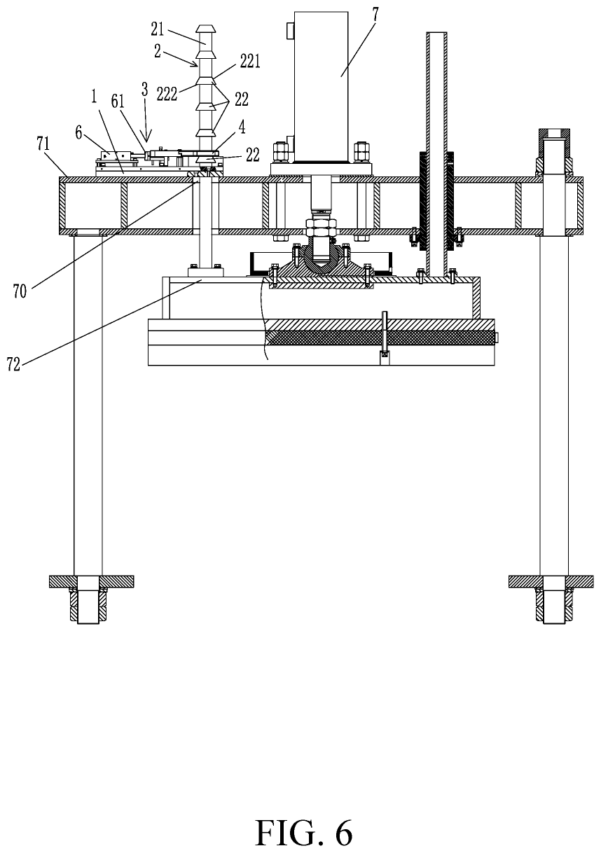

As shown in FIGS. 5 and 6, a top face 221 of the respective one defining ring 22 of the pull stud 2 is a conical surface, and a bottom face 222 of the respective one defining ring 22 is a plane. In other words, a diameter of a cross section of the respective one defining ring 22 is decreased upward from the bottom face 222 of the respective one defining ring 22, wherein a number of the multiple defining rings 22 is multiple so that the mold locking mechanism comprises multiple clamping positions to comply with various using requirements.

The guide rod 5 is screwed with at least one nut 51, and the at least one nut 51 contacts with the two tilted swing arms 4.

Referring to FIG. 6, the safety device is mounted on a hydraulic press 7, the bottom plate 1 of the safety device is fixed on a support plate 71 of the hydraulic press 7, and a bottom of the pull stud 2 of the safety device is disposed on a top of a mold holder 72 of the hydraulic press 7, such that the mold holder 72 of the hydraulic press 7 actuates the pull stud 2 to move upward and downward reciprocately. When the clamper 3 is in the clamping state, the mold holder 72 of the hydraulic press 7 drops downward and actuates the pull stud 2 to move downward. In the meantime, the bottom face 222 of one defining ring 22 abuts against and presses the two tilted swing arms 4 so that the drive device 6 does not drive the clamper 3 to switch to a unclamping state by using the pushing element 61, the mold holder 72 of the hydraulic press 7 drives the pull stud 2 to move upward so that the one defining ring 22 removes from the two tilted swing arms 4, and the pushing element 61 of the drive device 6 drives the clamper 3 to be in the unclamping state. Thereby, when the mold holder 72 of the hydraulic press 7 is manually controlled to move upward by pressing a switch, an upward moving distance of the mold holder 72 is not controlled easily.

When the upward moving distance of the mold holder 72 is excessive, the one defining ring 22 below the two tilted swing arms 4 moves upward to hit the two tilted swing arms 4. Due to the top face 221 of the respective one defining ring 22 is the conical surface, the two extensions 41 of the two tilted swing arms 4 slide across the top face 221 of the respective one defining ring 22 and move away from each other, during the one defining ring 22 hits the two tilted swing arms 4. Accordingly, after the two tilted swing arms 4 are hit by the one defining ring 22, the two tilted swing arms 4 are not broken.

The two extensions 41 of the two tilted swing arms 4 are arcuate so that when the two extensions 41 of the two tilted swing arms 4 contact with the bottom face 222 of the one defining ring 22, a contacting area of the two extensions 41 of the two tilted swing arms 4 is increased to enhance a loading capacity.

The hydraulic press 7 includes a passing hole 70 defined on the support plate thereof, and a bottom of the pull stud 2 is fixed on the mold holder 72 of the hydraulic press 7 via the passing hole 70.

When the hydraulic press 7 operates, the pushing element 61 of the drive device 6 drives the abutting projection 31 to move forward so that the clamper 30 is switched to be in the unclamping state, and the mold holder 72 of the hydraulic press 7 actuates the pull stud 2 to move upward and downward reciprocately. When the mold holder 72 of the hydraulic press 7 moves upward to a desired height and position, the clamper 30 is switched to be in the clamping state. Since the at least one defining ring 22 is located above the clamper 30, when a hydraulic system of the hydraulic press 7 produces a leakage and the mold holder 72 of the hydraulic press 7 drops downward, the bottom face 222 of the at least one defining ring 22 abuts against and presses the two tilted swing arms 4, hence the one defining ring 22 above the clamper 3 does not pass across the gap M of the two extensions 41 of the two tilted swing arms 4, as illustrated in FIG. 4. Accordingly, the mold holder 72 of the hydraulic press 7 does not drop continuously to cause unsafety or accident. A tensile strength of the pull stud 2 is so high enough that the safety device sustains a larger loading, for example, the tensile strength of the pull stud 2 is applicable for the hydraulic press 7 with a large tonnage to obtain using safety.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A safety device for a hydraulic press comprising: a bottom plate;
wherein the bottom plate includes a through orifice thereon and a pull stud inserted through the through orifice, and the pull stud includes a shank and at least one defining ring fitted on the shank, wherein the bottom plate further includes a clamper, and the clamper has an abutting projection mounted above a top of the bottom plate, wherein the abutting projection has two tilted swing arms rotatably connected on two sides thereof, and two extensions of the two tilted swing arms are located on two sides of the pull stud, wherein a respective one tilted swing arm includes an elongated orifice extending thereon from a central section of the respective one tilted swing arm, and the elongated orifice of the respective one tilted swing arm slidably accommodates a guide rod, wherein the bottom plate further includes a drive device mounted thereon and located behind the abutting projection, and the drive device includes a pushing element;
wherein in an original state, the clamper is in a clamping state so that two extensions of the two tilted swing arms move close to each other, and the respective one defining ring of the pull stud does not pass across a gap of the two extensions of the two tilted swing arms in the clamping state;
wherein the pushing element of the drive device pushes the abutting projection to move forward, such that the clamper is switched to be in an unclamping state, and the two extensions of the two tilted swing arms are spaced from each other so that the respective one defining ring of the pull stud passes across a gap of the two extensions of the two tilted swing arms.

2. The safety device as claimed in claim 1, wherein the bottom plate further includes a through orifice defined thereon, and the pull stud is inserted through the through orifice, wherein a central point of the through orifice is a datum point from which a virtual longitudinal axis extends, and a diameter of the shank of the pull stud and a diameter of the respective one defining ring are smaller than a diameter of the through orifice.

3. The safety device as claimed in claim 2, wherein in the clamping state, the gap of the two extensions on the virtual longitudinal axis is smaller than the diameter of the respective one defining ring of the pull stud; when the two extensions of the two tilted swing arms are spaced from each other, the gap of the two extensions of the two tilted swing arms on the virtual longitudinal axis is larger than the diameter of the respective one defining ring of the pull stud; and when the two extensions of the two tilted swing arms are spaced from each other, the gap of the two extensions of the two tilted swing arms on the virtual longitudinal axis is larger than the diameter of the through orifice of the bottom plate.

4. The safety device as claimed in claim 1, wherein the bottom plate further includes a positioning protrusion connected with the abutting projection and at least one returning spring defined between the positioning protrusion and the abutting projection.

5. The safety device as claimed in claim 1, wherein the abutting projection has two guiding blocks extending from two sides thereof and located on the bottom plate, and the two guiding blocks have two slide grooves defined therein, wherein the abutting projection is slidably defined between the two slide grooves.

6. The safety device as claimed in claim 1, wherein at least one tension spring is defined between the two tilted swing arms and is located ahead of the guide rod.

7. The safety device as claimed in claim 1, wherein a top face of the respective one defining ring of the pull stud is a conical surface, and a bottom face of the respective one defining ring is a plane, wherein a diameter of a cross section of the respective one defining ring is decreased upward from the bottom face of the respective one defining ring, wherein a number of the multiple defining rings is multiple.

8. The safety device as claimed in claim 1, wherein the guide rod is screwed with at least one nut, and the at least one nut contacts with the two tilted swing arms.

9. The safety device as claimed in claim 1, wherein the two extensions of the two tilted swing arms are arcuate.

10. The safety device as claimed in claim 1, wherein the bottom plate of the safety device is fixed on a support plate of the hydraulic press, the hydraulic press includes a passing hole defined on the support plate thereof, and a bottom of the pull stud is fixed on the mold holder of the hydraulic press via the passing hole, such that the mold holder of the hydraulic press actuates the pull stud to move upward and downward reciprocately.
